(19) United States
(12) Patent Application Publication
(10) Pub. No.: US 2025/0184410 A1
(43) Pub. Date: Jun. 5, 2025

(54) Signal Conversion Method and Signal Conversion System

(71) Applicant: Moxa Inc., New Taipei City (TW)

(72) Inventors: Shao-Hua Lee, New Taipei City (TW); Chih-Yang Chen, New Taipei City (TW)

(73) Assignee: Moxa Inc., New Taipei City (TW)

(21) Appl. No.: 18/660,202

(22) Filed: May 9, 2024

(30) Foreign Application Priority Data
Nov. 30, 2023 (TW) 112146499

(51) Int. Cl. H04L 69/08; H04L 43/0811; H04L 69/324

(52) U.S. Cl. CPC H04L 69/08; H04L 43/0811; H04L 69/324

(57) ABSTRACT

A signal conversion method includes transmitting an Ethernet packet from an Ethernet media access controller to a transceiver, stacking an Ethernet media access control protocol layer corresponding to the Ethernet packet to a wireless communication protocol layer by using a protocol stack for generating a wireless communication packet after the transceiver receives the Ethernet packet, and generating a wireless communication signal according to the wireless communication packet.

### BACKGROUND OF THE INVENTION

### 1. Field of the Invention

The present invention illustrates a signal conversion method and a signal conversion system, and more particularly, a signal conversion method and a signal conversion system capable of converting an Ethernet packet to a wireless communication packet.

### 2. Description of the Prior Art

With the rapid development of science and technology, the market share of Ethernet increases year by year. Ethernet is the most common technology used in a Local Area Network (LAN). Ethernet can transmit data through multiple nodes of the network. The nodes can be used for transmitting data packets through cables or fiber optic channels.

In current Ethernet devices, the data packets require a plurality of relay transitions to perform wireless communications. Therefore, since the packet is relayed multiple times, a high transmission delay and a synchronization difficulty may be introduced to the current Ethernet devices.

### SUMMARY OF THE INVENTION

In an embodiment of the present invention, a signal conversion method is disclosed. The signal conversion method comprises transmitting an Ethernet packet from an Ethernet media access controller to a transceiver, stacking an Ethernet media access control protocol layer corresponding to the Ethernet packet to a wireless communication protocol layer by using a protocol stack for generating a wireless communication packet after the transceiver receives the Ethernet packet, and generating a wireless communication signal according to the wireless communication packet.

In another embodiment of the present invention, a signal conversion method is disclosed. The signal conversion method includes receiving a wireless communication signal, generating a wireless communication packet according to the wireless communication signal, extracting an Ethernet media access control protocol layer corresponding to an Ethernet packet from the wireless communication packet, wherein the wireless communication packet is generated by stacking the Ethernet media access control protocol layer corresponding to the Ethernet packet to a wireless communication protocol layer, and transmitting the Ethernet packet from a transceiver to an Ethernet media access controller.

In another embodiment of the present invention, a signal conversion system is disclosed. The signal conversion system comprises an Ethernet media access controller, a transceiver, a wireless protocol processor, and a digital signal processor. The transceiver is linked to the Ethernet media access controller. The wireless protocol processor is coupled to the transceiver. The digital signal processor is coupled to the wireless protocol processor. The Ethernet media access controller transmits an Ethernet packet to the transceiver. The wireless protocol processor stacks an Ethernet media access control protocol layer corresponding to the Ethernet packet to a wireless communication protocol layer by using a protocol stack for generating a wireless communication packet after the transceiver receives the Ethernet packet. The digital signal processor generates a wireless communication signal according to the wireless communication packet. The wireless communication signal is emitted by a radio frequency module.

In another embodiment of the present invention, a signal conversion system is disclosed. The signal conversion system comprises an Ethernet media access controller, a transceiver linked to the Ethernet media access controller, a wireless protocol processor coupled to the transceiver, a digital signal processor coupled to the wireless protocol processor, and a radio frequency module coupled to the digital signal processor. The radio frequency module receives a wireless communication signal. The digital signal processor generates a wireless communication packet according to the wireless communication signal. The wireless protocol processor extracts an Ethernet media access control protocol layer corresponding to an Ethernet packet from the wireless communication packet. The wireless communication packet is generated by stacking the Ethernet media access control protocol layer corresponding to the Ethernet packet to a wireless communication protocol layer. The transceiver transmits the Ethernet packet to the Ethernet media access controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a transmitter side of a signal conversion system according to an embodiment of the present invention.

FIG. 2 is an illustration of performing a protocol stack of the transmitter side of the signal conversion system in FIG. 1.

FIG. 3 is a block diagram of a receiver side of the signal conversion system according to an embodiment of the present invention.

FIG. 4 is a flow chart of performing a signal conversion method by the transmitter side of the signal conversion system in FIG. 1.

FIG. 5 is a flow chart of performing a signal conversion method by the receiver side of the signal conversion system in FIG. 3.

### DETAILED DESCRIPTION

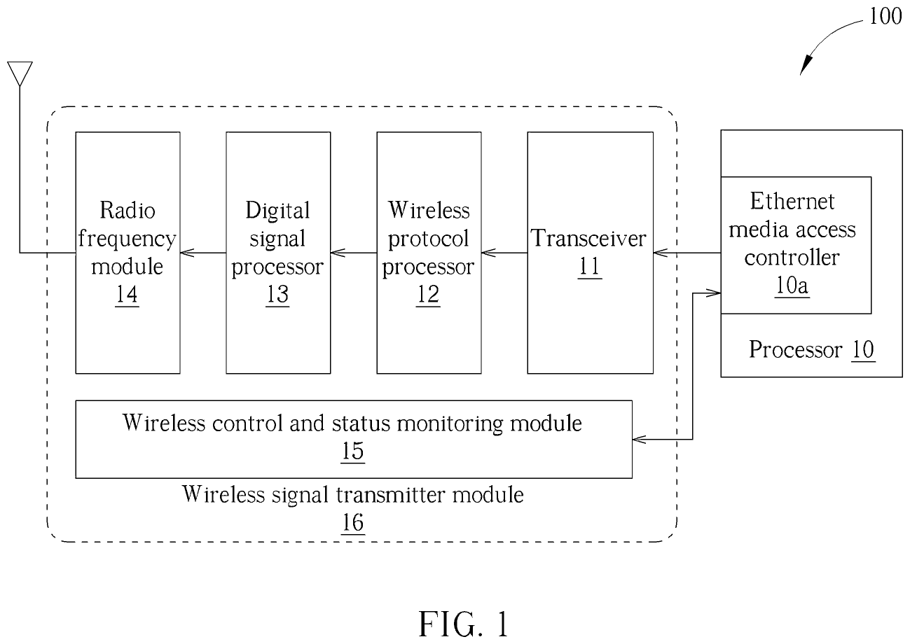

FIG. 1 is a block diagram of a transmitter side of a signal conversion system 100 according to an embodiment of the present invention. The transmitter side of the signal conversion system 100 includes a processor 10, a transceiver 11, a wireless protocol processor 12, a digital signal processor 13, and a radio frequency module 14. The processor 10 can be a switch chipset disposed in an Ethernet device for receiving external data signals. The processor 10 includes an Ethernet media access controller 10a. The Ethernet media access controller 10a can be a functional module or a circuit module supported by the processor 10. The Ethernet media access controller 10a can be used for transmitting and receiving Ethernet packets under a physical layer mode. The transceiver 11 is linked to the Ethernet media access controller 10a. The wireless protocol processor 12 is coupled to the transceiver 11. The digital signal processor 13 is coupled to the wireless protocol processor 12. The radio frequency module 14 is coupled to the digital signal processor 13. In the transmitter side of the signal conversion system 100, after the processor 10 receives the external data signal, the processor 10 can transmit the external data signal in a form of an Ethernet packet from the Ethernet media access controller 10a to the transceiver 11. After the transceiver 11 receives the Ethernet packet, the wireless protocol processor 12 can stack an Ethernet media access control protocol layer corresponding to the Ethernet packet to a wireless communication protocol layer by using a protocol stack for generating a wireless communication packet. The digital signal processor 13 can generate a wireless communication signal according to the wireless communication packet. Then, the wireless communication signal can be emitted by the radio frequency module 14. Here, the external data signals can be generated by a wired Ethernet device. The wireless communication signal can be a mobile communication signal, such as a fourth-generation (4G) mobile communication signal or a fifth-generation (5G) mobile communication signal. However, the present invention is not limited thereto. As previously mentioned operation mode, the transmitter side of the signal conversion system 100 can convert wired external data signals into wireless communication signals. Further, the transceiver 11, the wireless protocol processor 12, the digital signal processor 13, and the radio frequency module 14 can be integrated into a wireless signal transmitter module 16. The wireless signal transmitter module 16 can be externally coupled to the processor 10. The wireless signal transmitter module 16 and the processor 10 can also be disposed into the same module. The transmitter side of the signal conversion system 100 can be performed on a chip structure. The transmitter side of the signal conversion system 100 can also be performed on a multi-chip module. In the transmitter side of the signal conversion system 100, the Ethernet packet can be carried by a wired signal. The processor 10 can receive the external data signal with any reasonable signal format, such as a multimedia signal, a network signal, or a cable signal. The Format and content of the external data signal received by the processor 10 are not limited. Any reasonable hardware or technology modification falls into the scope of the present invention. Details of operating the transmitter side of the signal conversion system 100 are illustrated below.

As previously mentioned, the processor 10 includes an Ethernet media access controller 10a. After the processor 10 receives the external data signal, the Ethernet media access controller 10a can transmit the external data signal in the form of the Ethernet packet operated under a media access mode to the transceiver 11 operated under a physical layer mode. Therefore, the Ethernet packet can be transmitted to the transceiver 11 through a physical layer interface. It should be understood that a form of the Ethernet packet is a digital signal. Further, the Ethernet media access controller 10a can transmit the Ethernet packet in the digital format to the transceiver 11 directly through the physical layer interface. For example, the physical layer interface can be a Reduced Gigabit Media Independent Interface (RGMII) or a Serial Gigabit Media Independent Interface (SGMII). However, the present invention is not limited thereto. In particular, the Ethernet media access controller 10a can direct the Ethernet packet to a data queue address of the transceiver 11. Therefore, the transceiver 11 can receive and transmit the Ethernet packet by using a first-in-first-out (FIFO) mechanism according to the data queue address. Then, the wireless protocol processor 12 can convert the Ethernet packet into the wireless communication packet. Here, the wireless protocol processor 12 can use a technology of the protocol stack for “directly” stacking the wireless communication protocol layer (i.e., such as 5G NR, New Radio Layer) for converting the Ethernet packet to the wireless communication packet. Then, the wireless communication packet can be received by the digital signal processor 13. The digital signal processor 13 can perform a digital-to-analog converting process for generating the wireless communication signal according to the wireless communication packet. The wireless communication signal can be a mobile communication signal. Finally, the wireless communication signal can be emitted by the radio frequency module 14.

As previously mentioned, the Ethernet media access controller 10a can transmit the Ethernet packet in the digital format to the transceiver 11 directly through the physical layer interface. In other words, in the transmitter side of the signal conversion system 100, the Ethernet packet uses only one packet relay for converting to the wireless communication packet. The only one packet relay is introduced for converting the Ethernet packet to the wireless communication packet. The packet relay of the transmitter side of the signal conversion system 100 is performed during a transition between the Ethernet media access controller 10a and the transceiver 11. Since only one packet relay is required for converting the Ethernet packet to the wireless communication packet, the transmitter side of the signal conversion system 100 can provide the following advantages. First, since only one packet relay is required, transmission latency can be greatly reduced. Second, since the wireless protocol processor 12 directly stacks the wireless communication protocol layer during a signal processing process, the encoding and decoding processes of an additional communication protocol layer (i.e., such as a universal serial bus protocol layer) introduced between the processor 10 and the wireless protocol processor 12 can be avoided. Therefore, transmission efficiency can be greatly increased. Third, since only one packet relay is required, the synchronization operation between the wireless communication packet and the Ethernet packet has low complexity.

In the transmitter side of the signal conversion system 100, in FIG. 1, it can further include a wireless control and status monitoring module 15. The wireless control and status monitoring module 15 is linked to the Ethernet media access controller 10a for controlling the Ethernet media access controller 10a to perform control operations such as a connection and a disconnection operations, and monitoring a wireless network connection status for acquiring the wireless network connection status. For example, the wireless control and status monitoring module 15 can acquire access point information and a network name. The Ethernet media access controller 10a can synchronize the Ethernet packet and the wireless communication packet. As previously mentioned, the transmitter side of the signal conversion system 100 can provide low transmission latency. Therefore, the Ethernet media access controller 10a can control the timing of a transmitting terminal (i.e., the Ethernet media access controller 10a) of the Ethernet packet. Even if the Ethernet packet is converted into the wireless communication packet, timing offset is barely introduced. As a result, the transmitter side of the signal conversion system 100 can provide low transmission latency, and low complexity of synchronizing the Ethernet packet and the wireless communication packet. In an embodiment, the wireless protocol processor 12 can direct the Ethernet packet to a corresponding time stamp within a transceiving time period of the wireless communication packet for synchronizing the wireless communication packet and the Ethernet packet. However, any technology of using the time stamp, a header, or a timing signal for synchronizing the wireless communication packet and the Ethernet packet falls into the scope of the present invention.

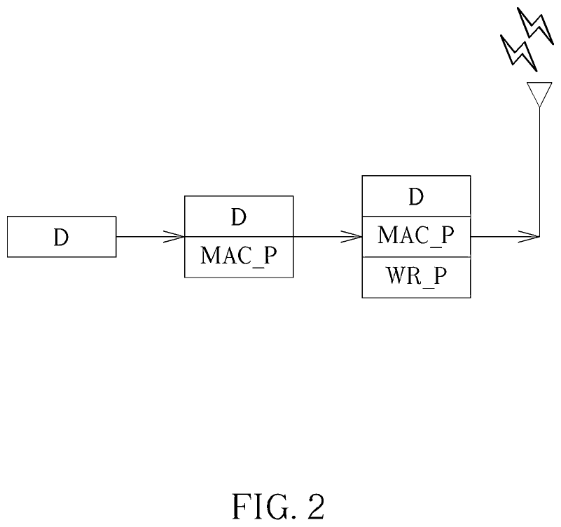

FIG. 2 is an illustration of performing the protocol stack of the transmitter side of the signal conversion system 100. In FIG. 2, in the transmitter side of the signal conversion system 100, the external data signal is denoted as D. The Ethernet media access controller 10a can carry the external data signal D on the Ethernet media access control protocol layer MAC_P, and can transmit it as a form of the Ethernet packet to the transceiver 11 through the physical layer interface. After the transceiver 11 transmits the Ethernet packet to the wireless protocol processor 12, the wireless protocol processor 12 can directly stack the wireless communication protocol layer WR_P (i.e., such as a wireless radio communication Layer). Therefore, a packet including the external data signal D, the Ethernet media access control protocol layer MAC_P, and the wireless communication protocol layer WR_P is the wireless communication packet. Finally, the wireless communication packet can be emitted by the radio frequency module 14. It should be understood that the wireless communication protocol layer WR_P can be a 4G mobile communication protocol layer, a 5G mobile communication protocol layer, or any reasonable wireless communication protocol layer.

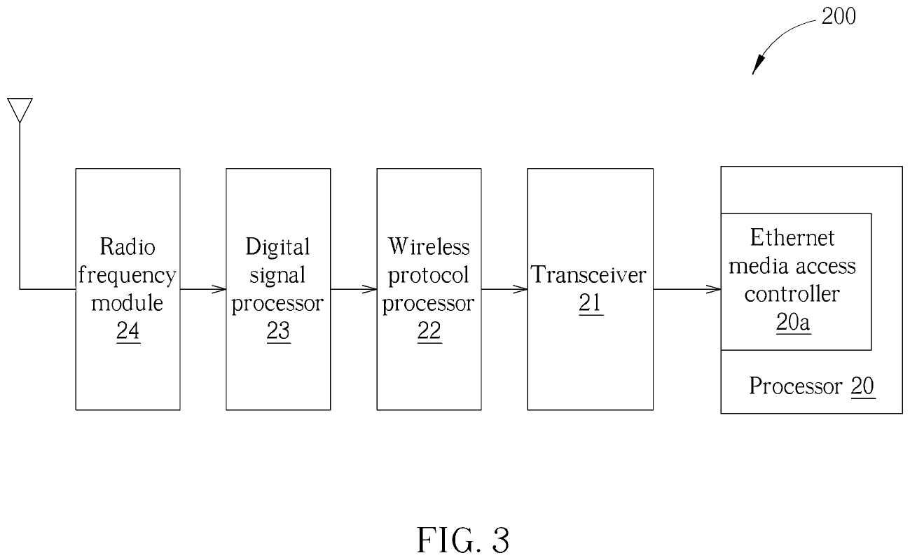

FIG. 3 is a block diagram of a receiver side of the signal conversion system 100 according to an embodiment of the present invention. The signal conversion system 100 can be applied to a receiver module. For avoiding ambiguity, the receiver side of the signal conversion system in FIG. 3 is called as the receiver side of the signal conversion system 200 hereafter. In FIG. 3, the receiver side of the signal conversion system 200 includes a transceiver 21, a wireless protocol processor 22, a digital signal processor 23, and a radio frequency module 24. First, the radio frequency module 24 receives the wireless communication signal. Then, the digital signal processor 23 can receive the wireless communication signal through the radio frequency module 24. The digital signal processor 23 can further generate the wireless communication packet according to the wireless communication signal. For example, the digital signal processor 23 can perform an analog-to-digital converting process for generating the wireless communication packet according to the wireless communication signal. It is understood that the wireless communication packet includes the external data signal D, the Ethernet media access control protocol layer MAC_P, and the wireless communication protocol layer WR_P (as shown in FIG. 2). Then, the wireless protocol processor 22 can extract the Ethernet media access control protocol layer MAC_P corresponding to the Ethernet packet from the wireless communication packet. As a result, the transceiver 21 can carry the external data signal D on the Ethernet media access control protocol layer MAC_P, and can transmit it as the form of the Ethernet packet to the Ethernet media access controller 20a. The Ethernet media access controller 20a is disposed in the processor 20. In other words, the Ethernet packet can be transmitted from the transceiver 21 to the Ethernet media access controller 20a through the physical layer interface. Finally, after the Ethernet packet is received by the Ethernet media access controller 20a, the Ethernet media access control protocol layer MAC_P can be decoded for acquiring the external data signal D. Here, the Ethernet packet can be carried by a wired signal. The wireless communication signal can be a mobile communication signal. Similarly, in the receiver side of the signal conversion system 200, only one packet relay is introduced for converting the wireless communication packet to the Ethernet packet. The packet relay is performed during a transition between the Ethernet media access controller 20a and the transceiver 21. Further, the Ethernet media access controller 20a directs the Ethernet packet to a data queue address of the transceiver 21. The Transceiver 21 can transmit the Ethernet packet by using a first-in-first-out (FIFO) mechanism according to the data queue address. Since only one packet relay is required for converting the wireless communication packet to the Ethernet packet, transmission latency can be greatly reduced.

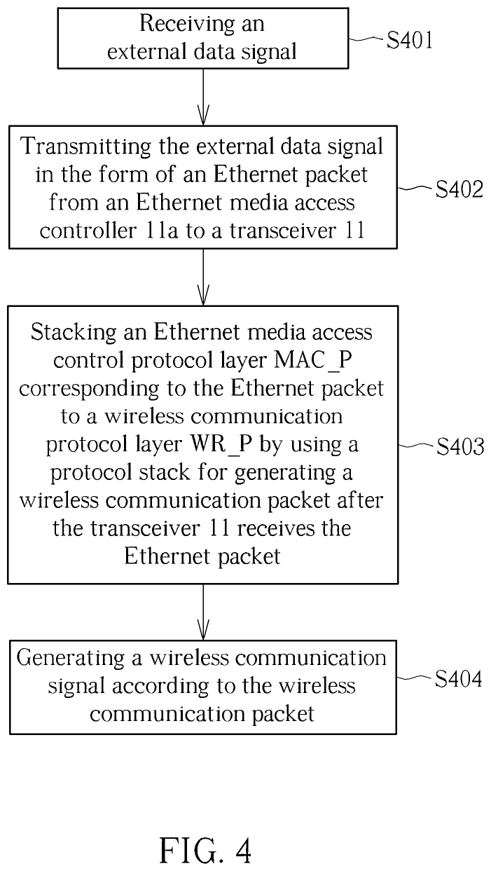

FIG. 4 is a flow chart of performing a signal conversion method by the transmitter side of the signal conversion system 100. The signal conversion method includes step S401 to step S404. Any reasonable hardware or technology modification falls into the scope of the present invention. Step S401 to step S404 are illustrated below.
step S401: receiving an external data signal;
step S402: transmitting the external data signal in the form of an Ethernet packet from an Ethernet media access controller 11a to a transceiver 11;
step S403: stacking an Ethernet media access control protocol layer MAC_P corresponding to the Ethernet packet to a wireless communication protocol layer WR_P by using a protocol for stack generating a wireless communication packet after the transceiver 11 receives the Ethernet packet;
step S404: generating a wireless communication signal according to the wireless communication packet.

Details of step S401 to step S404 are previously illustrated. Thus, they are omitted here. In the transmitter side of the signal conversion system 100, the processor 10 can execute the Ethernet media access controller 10a for performing a packet transmission function under the media access mode linked to the transceiver 11 operated under the physical layer mode through the physical layer interface. Therefore, the Ethernet packet can be directly received by the transceiver 11 through the physical layer interface. Then, the Ethernet packet can be stacked to the wireless communication protocol layer by using the protocol stack for generating the wireless communication packet. Therefore, the transmitter side of the signal conversion system 100 requires only one packet relay for converting the Ethernet packet to the wireless communication packet, thereby providing low transmission latency, high transmission efficiency, and easy synchronization properties.

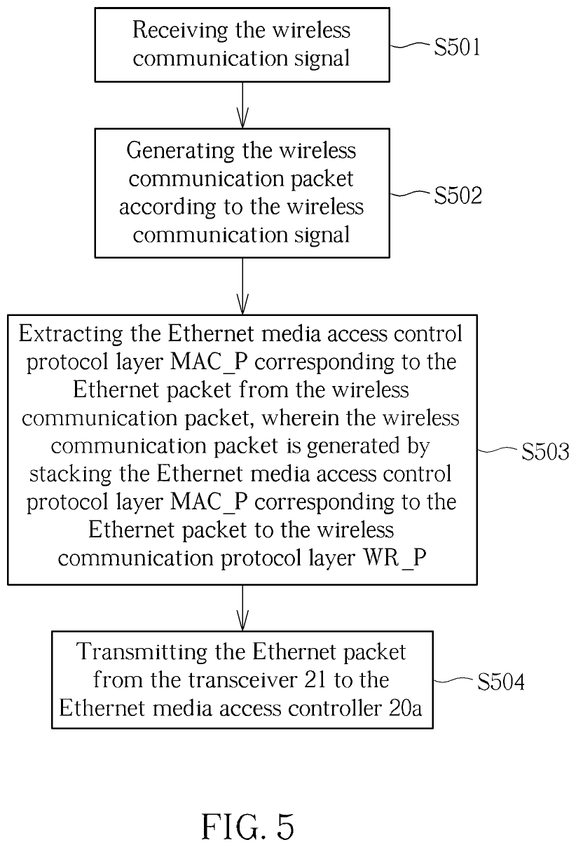

FIG. 5 is a flow chart of performing a signal conversion method by the receiver side of the signal conversion system 200. The signal conversion method includes step S501 to step S504. Any reasonable hardware or technology modification falls into the scope of the present invention. Step S501 to step S504 are illustrated below.
step S501: receiving the wireless communication signal;
step S502: generating the wireless communication packet according to the wireless communication signal;
step S503: extracting the Ethernet media access control protocol layer MAC_P corresponding to the Ethernet packet from the wireless communication packet, wherein the wireless communication packet is generated by stacking the Ethernet media access control protocol layer MAC_P corresponding to the Ethernet packet to the wireless communication protocol layer WR_P;
step S504: transmitting the Ethernet packet from the transceiver 21 to the Ethernet media access controller 20a.

Details of step S401 to step S404 are previously illustrated. Thus, they are omitted here. In the receiver side of the signal conversion system 200, similarly, since the wireless communication packet is generated by stacking the Ethernet media access control protocol layer MAC_P corresponding to the Ethernet packet to the wireless communication protocol layer WR_P, the wireless protocol processor 22 can directly extract the Ethernet media access control protocol layer MAC_P corresponding to the Ethernet packet from the wireless communication packet. Further, in the receiver side of the signal conversion system 200, only one packet relay is introduced for converting the wireless communication packet to the Ethernet packet, thereby providing low transmission latency, high transmission efficiency, and easy synchronization properties.

To sum up, the present invention discloses a signal conversion method and a signal conversion system. The transmitter side of the signal conversion system includes an Ethernet media access controller. The Ethernet media access controller can directly transmit an Ethernet packet to a transceiver through a physical layer interface. Further, the transmitter side of the signal conversion system does not require an additional communication protocol layer. It uses the protocol stack for directly stacking the Ethernet packet to the wireless communication protocol layer. Therefore, only one packet relay is introduced to the transmitter side of the signal conversion system for converting the Ethernet packet to the wireless communication packet. Further, the receiver side of the signal conversion system takes the same advantages as the transmitter side of the signal conversion system. Since only one packet relay is introduced, the signal conversion system can provide low transmission latency, high transmission efficiency, and low complexity synchronization operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal conversion method comprising:
transmitting an Ethernet packet from an Ethernet media access controller to a transceiver;
stacking an Ethernet media access control protocol layer corresponding to the Ethernet packet to a wireless communication protocol layer by using a protocol stack for generating a wireless communication packet after the transceiver receives the Ethernet packet; and
generating a wireless communication signal according to the wireless communication packet.

2. The method of claim 1, wherein transmitting the Ethernet packet from the Ethernet media access controller to the transceiver, is transmitting the Ethernet packet to the transceiver by using the Ethernet media access controller through a physical layer interface.

3. The method of claim 1, wherein generating the wireless communication signal according to the wireless communication packet comprises:
performing a digital-to-analog converting process by a digital signal processor for generating the wireless communication signal according to the wireless communication packet.

4. The method of claim 1, further comprising:
acquiring a wireless network connection status by monitoring a wireless network connection; and
synchronizing the Ethernet packet and the wireless communication packet.

5. The method of claim 4, wherein synchronizing the Ethernet packet and the wireless communication packet comprises:
directing the Ethernet packet to a corresponding time stamp within a transceiving time period of the wireless communication packet for synchronizing the Ethernet packet and the wireless communication packet.

6. The method of claim 1, wherein the Ethernet packet is carried by a wired signal, and the wireless communication signal is a mobile communication signal.

7. The method of claim 1, wherein transmitting the Ethernet packet from the Ethernet media access controller to the transceiver comprises:
transmitting the Ethernet packet in a digital format from the Ethernet media access controller to the transceiver directly through a physical layer interface.

8. The method of claim 1, wherein only one packet relay is introduced for converting the Ethernet packet to the wireless communication packet, and the packet relay is performed during a transition between the Ethernet media access controller and the transceiver.

9. The method of claim 1, wherein the Ethernet media access controller is disposed inside a processor, and the processor performs a packet transmission function by using the Ethernet media access controller.

10. The method of claim 1, wherein the Ethernet media access controller directs the Ethernet packet to a data queue address of the transceiver, and the transceiver receives the Ethernet packet by using a first-in-first-out (FIFO) mechanism according to the data queue address.

11. A signal conversion method comprising:
receiving a wireless communication signal;
generating a wireless communication packet according to the wireless communication signal;
extracting an Ethernet media access control protocol layer corresponding to an Ethernet packet from the wireless communication packet, wherein the wireless communication packet is generated by stacking the Ethernet media access control protocol layer corresponding to the Ethernet packet to a wireless communication protocol layer; and
transmitting the Ethernet packet from a transceiver to an Ethernet media access controller.

12. The method of claim 11, wherein generating the wireless communication packet according to the wireless communication signal comprises:
performing an analog-to-digital converting process by a digital signal processor for generating the wireless communication packet according to the wireless communication signal.

13. The method of claim 11, wherein transmitting the Ethernet packet from the transceiver to the Ethernet media access controller, is transmitting the Ethernet packet from the transceiver to the Ethernet media access controller through a physical layer interface.

14. The method of claim 11, wherein the Ethernet packet is carried by a wired signal, and the wireless communication signal is a mobile communication signal.

15. The method of claim 11, wherein only one packet relay is introduced for converting the wireless communication packet to the Ethernet packet, and the packet relay is performed during a transition between the Ethernet media access controller and the transceiver.

16. The method of claim 11, wherein the Ethernet media access controller directs the Ethernet packet to a data queue address of the transceiver, and the transceiver transmits the Ethernet packet by using a first-in-first-out (FIFO) mechanism according to the data queue address.

17. The method of claim 11, wherein after the Ethernet packet is received by the Ethernet media access controller, the Ethernet media access control protocol layer can be decoded for acquiring an external data signal.

18. A signal conversion system comprising:
an Ethernet media access controller;
a transceiver linked to the Ethernet media access controller;
a wireless protocol processor coupled to the transceiver; and
a digital signal processor coupled to the wireless protocol processor;
wherein the Ethernet media access controller transmits an Ethernet packet to the transceiver, the wireless protocol processor stacks an Ethernet media access control protocol layer corresponding to the Ethernet packet to a wireless communication protocol layer by using a protocol stack for generating a wireless communication packet after the transceiver receives the Ethernet packet, the digital signal processor generates a wireless communication signal according to the wireless communication packet, and the wireless communication signal is emitted by a radio frequency module.

19. The system of claim 18, wherein the Ethernet media access controller transmits the Ethernet packet to the transceiver through a physical layer interface.

20. The system of claim 18, wherein the digital signal processor performs a digital-to-analog converting process for generating the wireless communication signal according to the wireless communication packet.

21. The system of claim 18, further comprising
a wireless control and status monitoring module linked to the Ethernet media access controller and configured to monitor a wireless network connection status for acquiring the wireless network connection status;
wherein the Ethernet packet and the wireless communication packet are synchronized.

22. The system of claim 21, wherein the wireless protocol processor directs the Ethernet packet to a corresponding time stamp within a transceiving time period of the wireless communication packet.

23. The system of claim 18, wherein the Ethernet packet is carried by a wired signal, and the wireless communication signal is a mobile communication signal.

24. The system of claim 18, wherein the Ethernet media access controller transmits the Ethernet packet in a digital format to the transceiver directly through a physical layer interface, and the Ethernet packet is a digital signal.

25. The system of claim 18, wherein only one packet relay is introduced for converting the Ethernet packet to the wireless communication packet, and the packet relay is performed during a transition between the Ethernet media access controller and the transceiver.

26. The system of claim 18, wherein the Ethernet media access controller is disposed inside a processor, and the processor performs a packet transmission function by using the Ethernet media access controller.

27. The system of claim 18, wherein the Ethernet media access controller directs the Ethernet packet to a data queue address of the transceiver, and the transceiver receives and transmits the Ethernet packet by using a first-in-first-out (FIFO) mechanism according to the data queue address.

28. A signal conversion system comprising:
an Ethernet media access controller;
a transceiver linked to the Ethernet media access controller;
a wireless protocol processor coupled to the transceiver;
a digital signal processor coupled to the wireless protocol processor; and
a radio frequency module coupled to the digital signal processor;
wherein the radio frequency module receives a wireless communication signal, the digital signal processor generates a wireless communication packet according to the wireless communication signal, the wireless protocol processor extracts an Ethernet media access control protocol layer corresponding to an Ethernet packet from the wireless communication packet, the wireless communication packet is generated by stacking the Ethernet media access control protocol layer corresponding to the Ethernet packet to a wireless communication protocol layer, and the transceiver transmits the Ethernet packet to the Ethernet media access controller.

29. The system of claim 28, wherein the digital signal processor performs an analog-to-digital converting process for generating the wireless communication packet according to the wireless communication signal.

30. The system of claim 28, wherein the Ethernet packet is transmitted from the transceiver to the Ethernet media access controller through a physical layer interface.

31. The system of claim 28, wherein the Ethernet packet is carried by a wired signal, and the wireless communication signal is a mobile communication signal.

32. The system of claim 28, wherein only one packet relay is introduced for converting the wireless communication packet to the Ethernet packet, and the packet relay is performed during a transition between the Ethernet media access controller and the transceiver.

33. The system of claim 28, wherein the Ethernet media access controller directs the Ethernet packet to a data queue address of the transceiver, and the transceiver transmits the Ethernet packet by using a first-in-first-out (FIFO) mechanism according to the data queue address.

34. The system of claim 28, wherein after the Ethernet packet is received by the Ethernet media access controller, the Ethernet media access control protocol layer can be decoded for acquiring an external data signal.
